(19) United States
(12) Patent Application Publication
(10) Pub. No.: US 2009/0034748 A1
(43) Pub. Date: Feb. 5, 2009

(54) AMBIENT NOISE-REDUCTION CONTROL SYSTEM

(76) Inventor: Alastair Sibbald, Buckinghamshire (GB)

Correspondence Address: DICKSTEIN SHAPIRO LLP, 1825 EYE STREET NW, Washington, DC, 20006-5403, US

(21) Appl. No.: 12/279,303

(22) PCT Filed: Mar. 28, 2007
(86) PCT No.: PCT/GB07/01099

§ 371 Date: Aug. 13, 2008

(30) Foreign Application Priority Data
Apr. 1, 2006 (GB) 0606630.2

(51) Int. Cl. G10K 11/16

(52) U.S. Cl. 381/71.6

(57) ABSTRACT

The invention provides a noise reduction control system for an ear-worn speaker-carrying device (“ESD”). The system is configured to sense ambient noise and to develop electrical signals which can be used to reduce the amount of said ambient noise audible to a wearer of the ESD. The system sets a plurality of predetermined and discrete noise reduction levels and automatically responds to at least one controlling event, outside the control of the wearer, to set the degree of noise reduction to one of those discrete levels. Typically, the system inverts and filters the electrical signals relating to ambient noise and feeds the inverted and filtered signals to the speaker of the ESD in time for the speaker to generate sounds capable of interfering destructively with the ambient noise.

The present invention relates to ambient noise-reduction control systems, primarily for use with ear-worn speaker-carrying devices, such as earphones and headphones (such devices being referred to hereinafter as “ESDs” for convenience). The invention has especial, though not exclusive, application to ESDs intended for use in conjunction with portable electronic devices, such as personal music players and cellular phones.

The ambient noise to be reduced under the control of the invention is that occurring around an individual who is wearing an ESD. The ambient noise is detected by a microphone on (or inside) a housing that forms a part of the ESD, electronically inverted and filtered, and fed to the ESD's speaker, so as to create an acoustic signal which, in principle, is substantially equal in magnitude, but substantially opposite in polarity, to the ambient acoustic noise. Consequently, destructive wave interference occurs between the ambient acoustic noise and its inverse, generated via the speaker, and so the level of the ambient acoustic noise, as perceived by the listener, is reduced.

At present, some ESDs are wired directly to sound sources, such as personal music players and cellular phones, via short leads and connectors, and some are coupled to such sound sources via wireless links, using protocols such as the “Bluetooth” format. The present invention can be used with both wired and wireless couplings.

There are several distinct types or families of ESD in use at the present time, both as single, one-ear devices, and also as stereophonic pairs, as described below.
1. In-ear type (sealed), with ear canal sealing flange (typically termed “ear-bud”).
2. In-ear type (not sealed), with a relatively loose fit into the ear, and consequent acoustic leakage pathway around the device.
3. Pad-on-ear type, with foam disc pad which lies flat against the pinna (outer ear flap).
4. “Supra-aural” on-ear type with peripheral acoustic seal: as (3) but with a thicker peripheral acoustic seal around the rim so as to achieve some acoustic attenuation of the higher frequencies permeating into the ear from the outside world.
5. Circumaural: in which a larger housing is used for the device, slightly bigger than the pinna itself, such that when located in position against the side of the head, a large, cushion-type foam-rubber seal around the rim of the housing forms a substantial acoustic seal between the ambient and the inner cavity now existing between the ear and the inner surface of the shell of the device.

Types 1 and 5 both incorporate a form of acoustic seal in order to provide a degree of acoustic isolation for the wearer, but many find that this leads to various types of discomfort.

For example, Type 1 devices can be physically uncomfortable when lodged in the ear canal entrance for extended periods. Further, their acoustic isolating properties can be dangerous in terms of reducing wearers' awareness of their physical surroundings. Also, because the ear canal is effectively sealed, use of such devices in aircraft can cause ear “popping” and discomfort in response to changes in cabin pressure. Furthermore, if the housing of the device is brushed against an object, such as a pillow or item of clothing, a very loud (and distracting) mechanical transmission of the friction sound directly into the ear canal frequently occurs. Additionally, if the wearer is eating, the chewing noises are transmitted into the ear-canal via the mastoid bone, again creating a large and unpleasant acoustic signal.

Type 5 devices also strive to isolate the wearer's ears from the ambient and, whilst their construction is such that a small cavity is formed around the outer ear, such that the ear canal is not directly sealed itself, the ear canal is nevertheless coupled acoustically to this cavity. This sealed cavity around the ear is not ventilated, and therefore can quickly become warm, humid and uncomfortable. Also, if there are small imbalances between the left and right channel signals at low frequencies, which might be caused, for example, by two earphone devices not being seated perfectly symmetrically, unpleasant acoustic effects can be introduced by the occurrence of non-natural left-right phase differences which have been variously described as “phasey”, “sucking effect” and “ear-blocking”.

The sound isolation provided by acoustically sealed systems is a fixed feature: it can neither be varied, nor switched off. If a wearer wishes to hear the outside world briefly, say for conversation or for crossing a road, it is necessary to physically remove the ESD from the ear, and then replace it again afterwards. This is a major disadvantage in everyday usage, and can lead to potentially dangerous situations should wearers leave the devices in place continuously.

The present invention relates primarily to usage with device types (2), (3) and (4) in which there is some acoustic leakage present around the device itself, linking the wearer's ear to the ambient. Although this naturally makes electronic noise-reduction more difficult to achieve, the acoustic leakage affords a much more comfortable listening experience for the wearer, and this is a very important factor. The comfort factor of the pad-on-ear type of device is superior to the circumaural type in that (a) it is intrinsically relatively lightweight; (b) it allows natural air-flow and ventilation around the ears, thus avoiding sweatiness and irritation; and (c) it is not susceptible to artefacts associated with the actions of eating and chewing.

Another prime advantage of ESDs with relatively large acoustic leakage is that most of the human directional hearing capabilities remain intact, so that wearers still possess spatial hearing ability with the devices in place. Consequently, in the absence of loud music or noise-reduction signals, users can hear the world in a reasonably natural way. This is a safe default situation, unlike an acoustically sealed system that isolates a listener from the physical environment.

It is further important to note that existing ambient noise-reduction systems for ESDs are based on either one of two entirely different principles, namely the “feedback” method, and the “feedforward” method.

The feedback method, described for example in U.S. Pat. No. 4,455,675, is based upon a closed-back, circumaural-type ESD. Inside the cavity that is formed between the ear and the inside of the ESD's shell, a miniature microphone is placed directly in front of the ESD's loudspeaker, and it is coupled back to the loudspeaker via a negative feedback loop (an inverting amplifier), such that it forms a simple servo system in which the loudspeaker is constantly attempting to create a null sound pressure level at the microphone. Although this principle is simple, it is quite difficult to implement efficiently in practice, especially in pad-on-ear format.

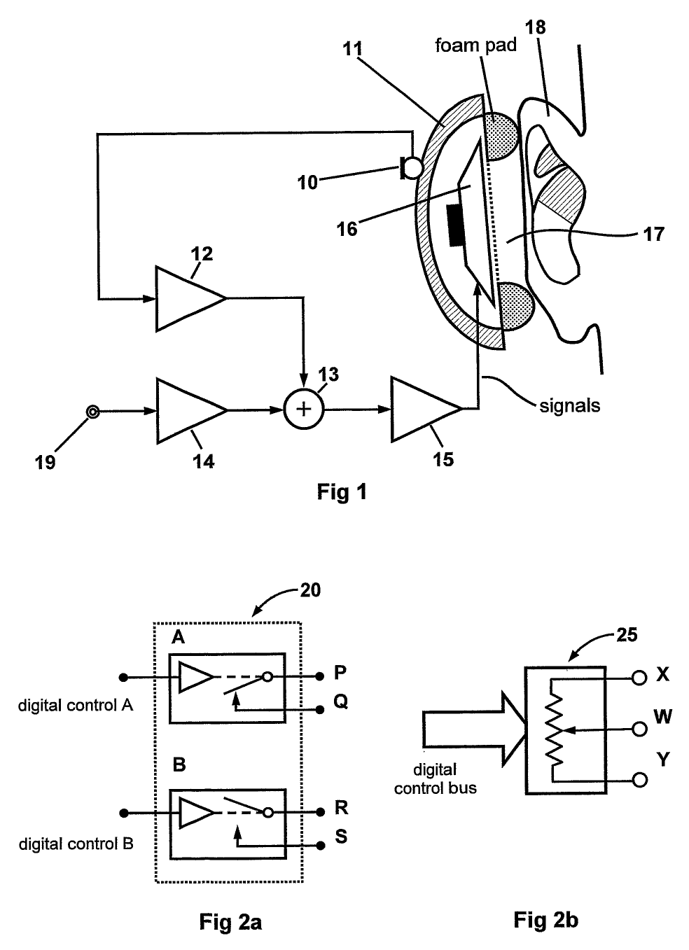

The feedforward method is disclosed, for example, in U.S. Pat. No. 5,138,664 and is depicted in basic form in FIG. 1. It can be employed with all of the different types of ESD described above. In contrast to the feedback system, however, a microphone 10 is placed on the exterior of the ESD's shell 11 in order to detect the ambient noise signal on its way into and around the device. The detected signal is pre-amplified and inverted in a suitable inverting amplifier 12 and added at 13 to the drive signal, supplied to the combining circuit 13 by way of a buffer amplifier 14, which is fed by way of a drive amplifier 15 to the ESD's loudspeaker 16, thus creating a composite signal S containing (say) a music component that the wearer desires to hear, and a noise reduction signal component. As a consequence, destructive wave reduction occurs between the noise reduction signal component of the composite signal S and the incoming ambient acoustic noise signal, adjacent to the outlet port of the loudspeaker 16, within a cavity 17 formed between the ESD's shell 11 and the outer ear shown schematically at 18. For this to occur, the noise reduction component of the composite signal S must have a magnitude which is substantially equal to that of the incoming noise signal, and it must be of substantially opposed polarity (that is, inverted, or 180° shifted in phase with respect to the noise signal). In practice, it is also necessary to introduce some electronic signal-processing at the signal inversion stage, in the form of one or more electronic filters, in order to match the amplitude and phase of the cancellation signal to those of the noise signal as closely as possible, as is disclosed in UK Patent Application No. GB 0701483.0, which is assigned to the present applicant and incorporated herein in its entirety by reference.

The basic feedforward method of ambient noise reduction is simple to implement, and a working system for use with ordinary earphones can be assembled at low cost using a simple electret microphone capsule and a pair of operational amplifiers to amplify and invert its analogue signal, prior to mixing, as at 13, with an audio drive signal, such as a music signal, fed to the ESD's speaker. This is done via an adjustable gain means (not shown), such as a potentiometer, in order to adjust the magnitude of the noise reduction component of the signal S to substantially equal that of the ambient noise. Some measure of noise reduction can be achieved with this method and, although current systems are far from perfect, this feedforward principle forms the basis of various commercially available noise-reducing earphones. However, in such systems, even when the noise reduction signal is optimally adjusted and balanced, there remains a considerable residual noise signal, and so it is common to observe that most commercial systems are only claimed to operate below about 1 kHz; i.e. with a bandwidth similar to that of the feedback method, and to provide relatively modest amounts of noise reduction.

Some currently available noise-reducing earphones allow the user to switch off the noise reduction function, whereupon the loudspeaker connections of the device are switched away from the output of the internal noise-reducing drive amplifier 15 directly to the audio input connections (shown schematically at 19), thus acting as a conventional earphone if the battery has expired, or in order to conserve battery energy.

The long-standing situation of poor noise reduction efficacy has been changed recently by the invention of a much more efficient feedforward noise reduction system based on the usage of accurately time-aligned signals and an associated microphone technology, described and claimed in UK Patent Application No. GB 0601536.6 and its counterpart International Patent Application No. PCT/GB2007/000120, both of which are assigned to the present applicant and incorporated herein in their entirety by reference. This system provides a greater degree of noise reduction, and is effective up to higher frequencies (e.g. in the order of 3.5 kHz) than prior-art systems.

It has now been determined by the inventor that there is considerable merit in providing for automatic variation in the amount or degree of ambient noise reduction that is effected, according to the circumstances under which the ESD is being used, and hence the present invention aims to provide a noise reduction control system in which the degree of ambient noise reduction imposed can be controlled by one or more external events; i.e. events which are outside the control of a wearer of the ESD, thus permitting various modes of operation to be implemented.

According to the invention there is provided a noise reduction control system for ESDs, comprising means for sensing ambient noise on its way towards an ear of a wearer of an ESD, for developing electrical signals indicative of said noise and for utilising said signals to reduce the amount of said ambient noise audible to a wearer of the ESD, and control means for setting a plurality of predetermined and discrete levels for said reduction; said control means further comprising response means for automatically responding to at least one controlling event, outside the control of said wearer, to set the degree of said reduction to a preselected one of said discrete levels.

Preferably the system further comprises means for inverting and filtering said electrical signals and for feeding said inverted and filtered signals to a loudspeaker means in said ESD in time for the loudspeaker means to generate sounds capable of interfering destructively with said sensed ambient noise when it arrives in the vicinity of said loudspeaker means.

It is further preferred that the system also comprises a source of further electrical signals relating to sounds intended for the listener's attention, and means for merging the further electrical signals with the inverted signals to create a composite signal for application to said loudspeaker means.

In one preferred example of the invention, the sounds intended for the listener's attention comprise music. Alternatively, or in addition, the sounds may be speech or other sounds received over a telecommunications link.

The response to the controlling event may be instantaneous, delayed or subjected to a time profile such as a ramp function.

In some preferred embodiments, said control means is adapted to separately control the said inverted signals and the said further electrical signals relating to sounds intended for the listener's attention. In such circumstances it is particularly preferred that the control means comprise a digital signal processor.

It is further preferred in some embodiments to provide plural channels for respective electrical signals relating to sounds intended for the listener's attention, for said control means to separately control the said signals in at least a first and a second of said channels.

The invention may receive external signals for the attention of the listener by way of direct electrical connections and/or through wireless communication.

Where a wireless communication is employed, it is preferred that such communication conforms to Bluetooth protocols.

The invention may beneficially be employed in association with an audio system providing 3D-audio virtualisation.

The invention also encompasses personal music players or cellular telephone devices incorporating one or more components of any of the aforementioned inventive systems.

The present invention thus provides a system for variable, controllable ambient noise-reduction for an ESD user. It is especially suited for use with the efficient time-alignment system described and claimed in the aforementioned UK Patent Application, that is effective to frequencies up to, and beyond, 3 kHz, in contrast to the sub-1 kHz limit of presently available commercial products. Included amongst advantages of the invention are that the associated ESD type is both comfortable in use (being lightweight, not rigidly clamped to the head, and affording some ventilation), and that the amount or degree of noise-reduction that is effected may be electronically controllable; both of these characteristics being particularly desirable for earphones intended for use with mobile electronic devices. The noise-reduction level can be controlled in a binary “on-off” mode, or it can be switched directly between different pre-determined levels in a range, or it can be subjected to a time profile, such as a ramp function, to provide adjustment between levels on a “continuously variable” basis, either smoothly or in discrete increments.

The continuously variable function enables smoothly faded transitions to be made between different levels of ambient noise reduction, as will be described. For example, when initially activated, the ambient noise reduction can be caused to fade from its “off” value of reduction factor (RF) of 0%, to its maximum effect (RF=100%) over a period of, say, one second; thereby affording the listener a smoothly achieved transition, free from audible clicks and other unpleasant switching artefacts.

The control of noise-reduction level is exercised in response to the occurrence of selected events which themselves are outside the listener's control, thus enabling various automatic functions to be implemented for enhanced user satisfaction and safety.

In addition to directly connected ESD applications, the invention is also applicable to telephony applications such as radio-linked (Bluetooth) ESDs, where an incoming call can be used to trigger a pre-determined sequence of events, and where the cessation of the call can restore the original listening conditions for the user.

In practice, the amount of active noise reduction that can be achieved is limited by physical variables related to ESD placement and the like, and it varies with frequency over the range of operation. For the purpose of illustration it will be assumed, in the examples that follow, that a relatively efficient ambient noise reduction system is used, affording 20 dB of noise reduction at the eardrum of the ESD's wearer, and hence the RF of 100% corresponds to 20 dB noise reduction.

The invention can be applied to both feedback and feedforward types of ambient noise reduction, although it is best-suited to feedforward systems, where there is intrinsic acoustic leakage from the ambient to the eardrum. For clarity of description, the examples herein relate to the feedforward method. Also, for simplicity in the accompanying Figures, a single microphone system has been depicted, but it should be noted that a time-aligned, multi-microphone arrangement (for example of the kind described and claimed in the aforementioned UK Patent Application No. GB 0601536.6 and International Patent Application No. PCT/GB2007/000120) is preferred, because it is more effective in use.

In order that the invention may be clearly understood and readily carried into effect, certain embodiments thereof will now be described, by way of example only, with reference to the accompanying drawings, of which:

FIG. 1 shows, in block diagrammatic form, a conventional feedforward circuit arrangement for ambient noise reduction;

FIGS. 2a and 2b show respectively electronic analogue switching and gain-adjustment devices suitable for use in systems according to examples of the invention;

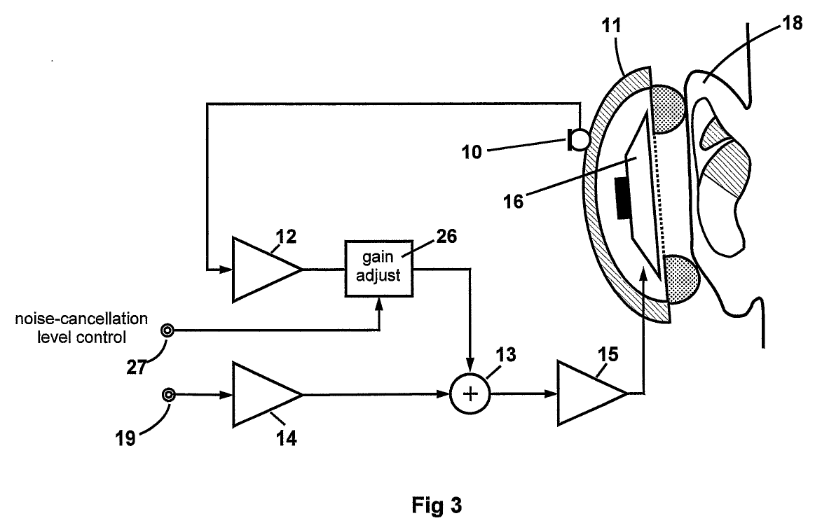

FIG. 3 shows a circuit arrangement for a system in accordance with a second embodiment of the invention;

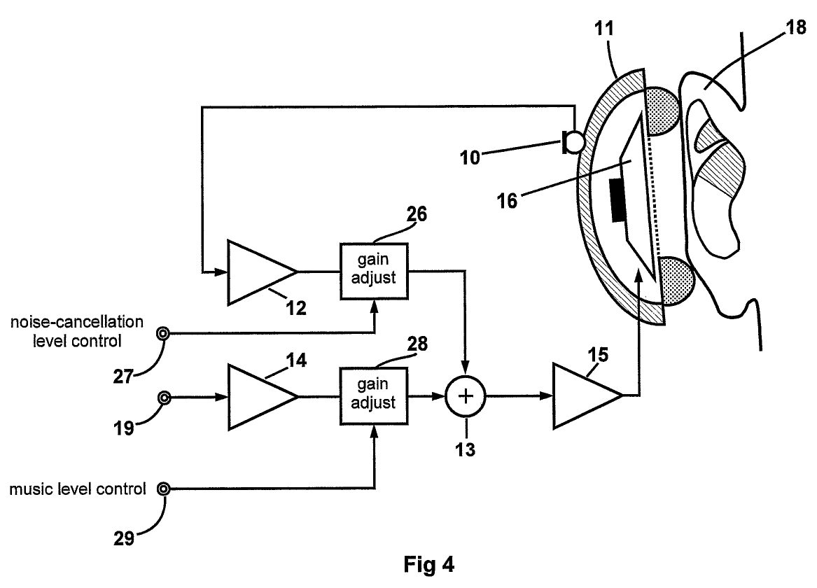

FIG. 4 shows a circuit arrangement for a system in accordance with a third embodiment of the invention;

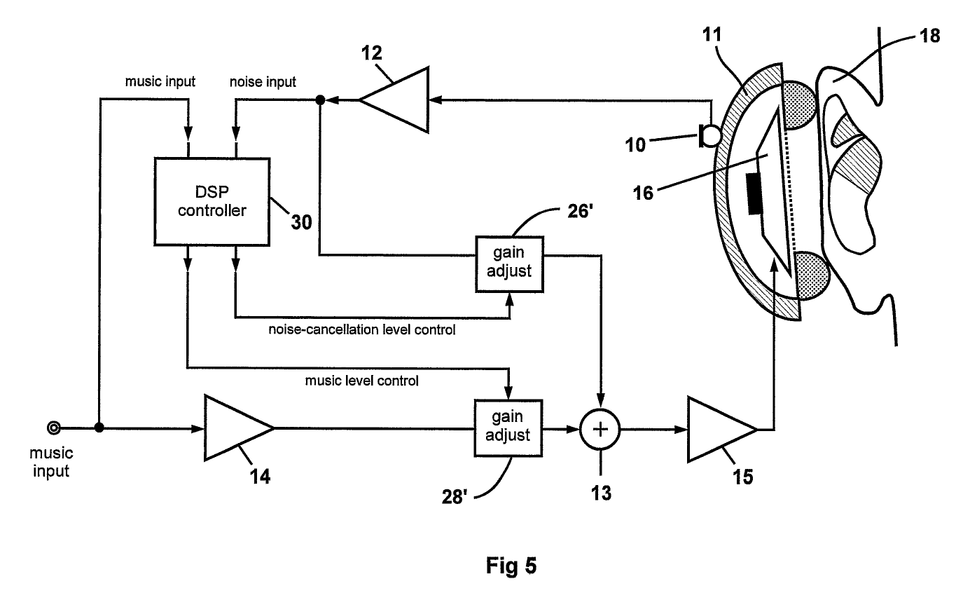

FIG. 5 shows a circuit arrangement for a system in accordance with a fourth embodiment of the invention;

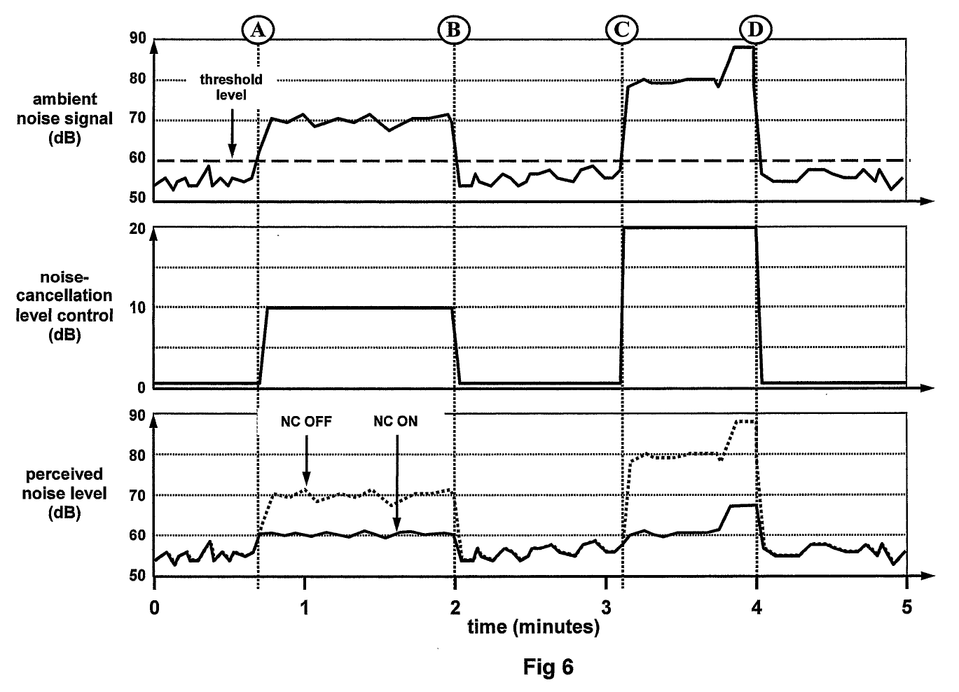

FIG. 6 shows graphs explanatory of the operation of a system according to an example of the invention configured as an ambient noise limiting system;

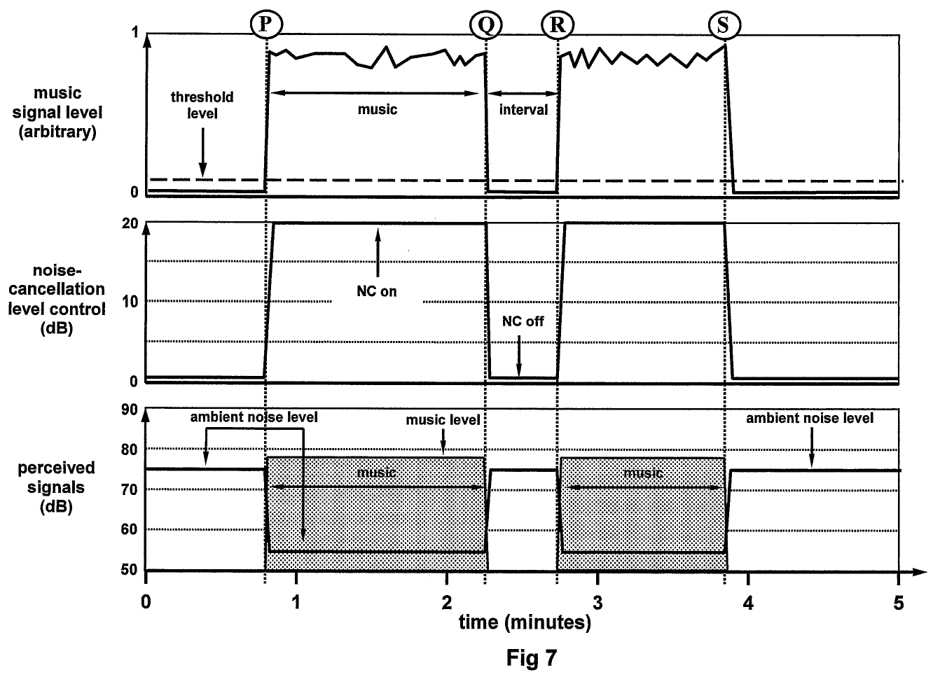

FIG. 7 shows graphs explanatory of the operation of a system according to an example of the invention configured to implement music-dependent ambient noise control;

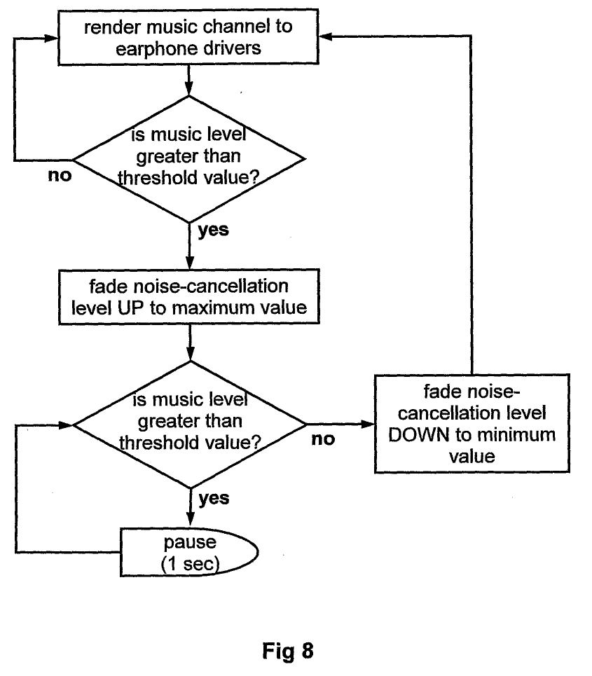

FIG. 8 shows a flow diagram explanatory of the operation of the embodiment of FIG. 7; and.

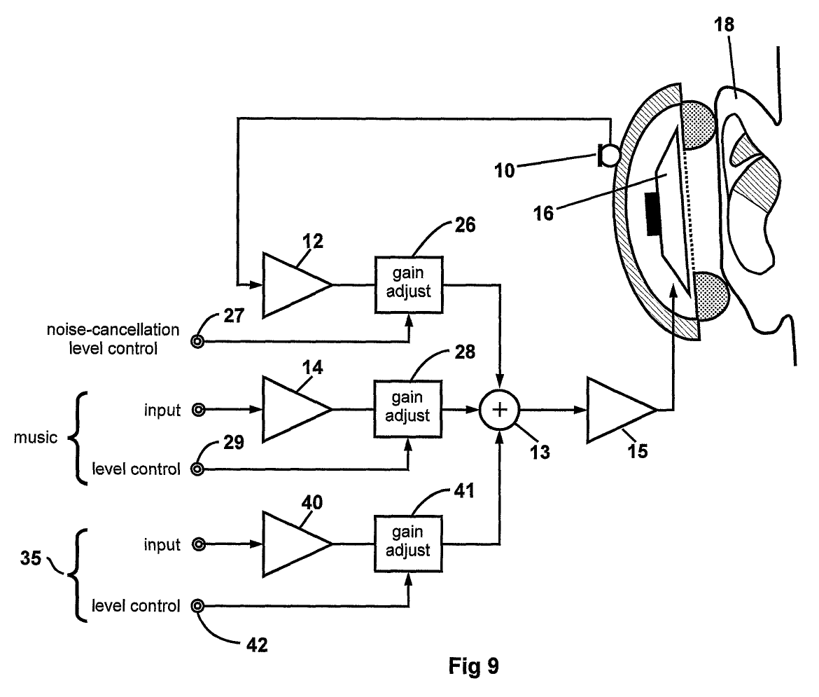

FIG. 9 shows a system in accordance with an example of the invention configured to implement electronic control over noise reduction, music and telecommunications signals.

Whilst the following examples and drawings relate to an analogue circuit implementation, ambient noise reduction signal processing can alternatively or additionally be carried out in the digital domain; the invention being equally applicable to analogue and/or digital processing routes.

Some preferred embodiments of the invention provide an ambient-noise reduction system having a variable degree of reduction that can be controlled by one or more external events. Each controlling event can initiate one or more actions that control the degree of ambient noise reduction, using one or more of several different operating modes. Some illustrative examples of these controlling events, actions and operating modes are listed below, followed by descriptions of various embodiments and two automatic operating modes afforded by the invention.

### Examples of Controlling Events

E1. Incoming call activation. An incoming telephone call triggers one or more actions, or a sequence of events, such as activating otherwise dormant noise reduction whilst the call is in progress, and then switching it off again when the call is terminated.
E2. Clock and timer control. A local electronic clock or timer is used to control the noise reduction level for a prescribed period of time. For example, a wearer travelling on an aircraft might wish to sleep in silence until a particular time, and then have the ambient noise restored to serve as a gentle wake-up alarm method. Alternatively, a wearer using full noise reduction might wish to have the ambient noise restored temporarily for, say 10 seconds, in order to have a brief conversation, after which full noise reduction is restored again.
E3. Detection of motion. A motion detector transducer is used to detect movement of the wearer's head. It activates the noise reduction system whilst the wearer is substantially motionless, which would be the case if they were asleep or listening to music, but when the wearer stirs and moves around, the noise reduction is switched off to restore the ambient sounds.
E4. Auto-Noise Mode. The ambient noise signal is monitored by a microprocessor and compared to a threshold value, such that when the ambient noise level around the user exceeds the threshold level, the noise reduction is activated. This is done in a proportional way such that the system acts as a “limiter”, or automatic gain control (AGC) for real-world noise, as is described subsequently.
E5. Auto-Music Mode. An incoming audio/music signal is monitored by a microprocessor and compared to a threshold value, such that when music is playing, or when other audio signals are present, the noise reduction is activated. When the music stops, for example between tracks, or because it has been switched off or paused, the noise reduction is caused to be switched off, attenuated or faded down to restore the ambient sounds for the wearer.

### Examples of Actions

A1. On/Off-instant. The noise reduction is switched ON or OFF instantly.
A2. On/Off-faded. The noise reduction is smoothly faded ON or OFF over a predetermined or selected period.
A3. Safe level. The noise reduction level is switched or faded to a preset, mid-value for the user's safety, say for example −6 dB, such that ambient sounds can still be heard by the user, albeit at a reduced loudness level (50% for −6 dB), in order to maintain some awareness for alarms and the like.

### Examples of Operating Modes

M1. Toggle. An event triggers an action, and cessation of the event restores the initial conditions.
M2. Monostable. An event triggers an action for a pre-determined period of time.
M3. Bistable. One event triggers an action, and another event restores the initial conditions.
M4. Automatic. Various “auto” modes: for example, Auto-Noise Mode (E4) and the Auto-Music Mode (E5), above.

FIG. 1, to which reference has already been made, shows a block diagram of the fundamental components and structure of a feedforward-type ambient noise reduction system. The ESD in this instance comprises a headphone, and a microphone 10 (or preferably an array of microphones) is placed on the headphone shell 11 to register incoming ambient noise, and generates electrical signals, indicative of said incoming noise, which are fed to a pre-amplifier, filter and inverter stage 12, after which the signal is summed at 13 with signals relating to incoming audio (e.g. music) intended for the listener's attention (after they have been suitably buffered at 14), and the combined noise-reduction and music/audio signals are fed to a drive amplifier 15 that is capable of driving the earphone loudspeaker driver transducer 16. The overall system gain is chosen such that the amplitude of the resultant acoustic noise reduction signal at the eardrum is substantially identical to that of the incoming ambient noise signal at the eardrum, thus ensuring maximum destructive reduction of the ambient noise. As described in the aforementioned UK patent application, great care must be also be taken to ensure that the phase of the two signals is matched at the eardrum, preferably by engineering a time-aligned system and by means of appropriate electronic filtering.

In order to vary and control the amount or degree of noise reduction which is carried out, the magnitude of the noise reduction signal must be switched or reduced from its maximum, optimal value, to some other value, such as zero. It will be appreciated that this could be done at several points in the circuit of FIG. 1, and ideally at the output of the pre-amplifier/inverter stage 12, prior to signal summation. The gain reduction can be carried out using either a solid-state analogue switch 20 (FIG. 2a), or an electronic potentiometer 25 (FIG. 2b).

One example of a suitable analogue switch is MAX325CPA (manufactured by Maxim), which is a double-pole double-throw switch based on coupled MOSFET devices having low Ron values (˜33Ω). FIG. 2a shows one half of this device, in which a digital control signal A opens the connection between terminals P and Q, and a digital control signal B closes the connection between terminals R and S. Examples of suitable electronic potentiometers include the AD8400 series (manufactured by Analog Devices), and also the AD5207, which comprises a 256-step, dual 10 kΩ potentiometer, with serial 8-bit digital input. These devices behave as analogue potentiometers, but with the “slider” position set by an 8-bit digital control word.

An arrangement for switching between different levels of ambient noise reduction is depicted in block form in FIG. 3. In this case, the gain of the noise signal can be controlled in a variable manner, typically in 256 increments of gain, by addressing the electronic potentiometer 26 with the required 8-bit digital number. Consequently, if it is required to activate the noise reduction signal from an OFF state (RF=0%; digital “0”) to a fully ON state (RF=100%; digital “256”), then the potentiometer is addressed rapidly with incrementing numbers from 0 to 256 over a brief period, say one or two seconds, thereby causing the ambient noise reduction to fade smoothly into maximum effect. This is much more pleasing and comfortable for the listener than to hear a sudden transition.

A further degree of sophistication can be achieved by applying a similar, controllable, variable-gain stage 28 to the music stage, prior to its summation with the noise signal, as shown in FIG. 4. This enables independent dual control of both the noise reduction level and the music level, which in turn allows various automatic modes of operation to be implemented, using the system of FIG. 5.

FIG. 5 is an extension of FIG. 4, in which a digital signal processor (DSP) 30 has been incorporated to monitor both the music input and the ambient noise signal from the microphone, or either of these. It is wired to, and controls, the control buses of both the ambient noise gain control stage 26′ and the music signal gain control stage 28′, thus providing the ability to fade either signal, independently, between 0% and 100%, or between any intermediate values, as rapidly or as slowly as required.

Two automatic mode embodiments, already briefly referred to above as E4 (Auto-Noise Mode) and E5 (Auto-Music Mode) will now be described in more detail.

### Auto-Noise Mode (E4):

The purpose of this mode of operation is to allow a wearer of an ESD to hear all the low-level ambient sounds, but to limit excessively loud sounds. For example, if the wearer is walking through a town, it would be advantageous (and safer) to hear the sounds of cars approaching, people tanking and the like, but, when walking past a very noisy construction site, or when a high-speed train passes at a railway station, it would be very desirable to reduce these brief occurrences of very loud noise to a more comfortable level.

This can be achieved using the circuit shown in FIG. 5, in which the incoming ambient noise signal is monitored by the DSP 30 and compared to a pre-determined threshold value such that, when the ambient noise level around the user exceeds this threshold level, the noise reduction is activated. This is done in a proportional way such that the system acts as a “limiter”, or automatic gain control (AGC) for real-world noise. If the maximum noise reduction capability of the system is, say, −20 dB, and the threshold level is set to 60 dB, FIG. 6 depicts the time course of an example series of events in the course of an imaginary town traveller, over a five minute period, to illustrate this embodiment of the invention.

The uppermost graph of FIG. 6 shows the ambient noise level, in dB units, as a function of time over a five minute period, with a threshold level indicated at 60 dB, and four event markers A, B, C and D. The central graph shows the noise reduction level control, and represents the amount of ambient noise reduction that is implemented by the DSP, in the range 0 dB to a maximum of 20 dB. The lowermost graph of FIG. 6 indicates the resultant noise level that is perceived by the wearer after noise reduction has taken place. There are two plots on this graph: the dotted line represents the perceived noise level with the system switched OFF, and the solid line indicates the perceived noise level with the system switched ON.

Initially, the ambient noise level is quite low, at 55 dB, but at point A, a noisy truck parks besides the wearer, raising the ambient noise level to 70 dB. This exceeds the activation threshold, and so the DSP 30 adjusts the gain of the noise reduction stage to implement 10 dB of ambient noise reduction, thus reducing the perceived noise level at the wearer's eardrums to 60 dB. At point B, the truck moves on, the ambient noise level reverts to its original 55 dB, thus falling below threshold, and the DSP 30 switches the noise reduction off again. At point C, the wearer passes a noisy construction suite which generates an ambient noise level of 80 dB, and so the DSP effects −20 dB noise reduction, bringing the perceived level by the listener to be only 60 dB once again. However, this −20 dB is the maximum degree of available noise reduction, and so a further rise in ambient noise level, just before marker D, causes the perceived noise level to increase linearly beyond the 60 dB target. The purpose of mentioning this latter is to illustrate the benign nature of the system, in that overloading beyond the maximum noise reduction capability does not cause detrimental artefacts.

### Auto-Music Mode (E5):

The purpose of this mode of operation is to switch on maximum ambient noise reduction when the music is playing, and to switch it off when the music channel is silent, in order that the wearer can hear all ambient sounds when the music is not playing.

For example, if the wearer of an ESD is travelling on a noisy underground train, it would be very desirable (and safer) to hear all of the local environmental sounds in between music tracks, or in the silent pauses during radio programmes. Additionally, if the wearer wished to alight from one train, and then catch another, it would be advantageous to pause the music track, at which point the ambient noise reduction would be caused to be switched off, thus allowing the wearer to hear normally whilst negotiating the transition between trains, and then when the music is switched on again, the noise reduction is also activated automatically to maximum effect.

This is easier than having to switch both the music and the noise reduction off and on separately, and it is safer for the wearer than leaving the ambient noise reduction switched on continuously.

This example is illustrated in FIG. 7, which depicts the time course of an example series of events in the course of an imaginary underground train commuter over a five minute period.

The uppermost graph of FIG. 7 shows the music signal level, in arbitrary units (0 to 1), as a function of time over a five minute period, with a threshold level indicated at about 5% of maximum, and four event markers P, Q, R and S. The central graph shows the noise reduction level control, and represents the amount of ambient noise reduction that is implemented by the DSP, in the range 0 dB to a maximum of 20 dB. Here, it is simply switching between OFF (0 dB) and ON (20 dB). The lowermost graph of FIG. 7 indicates the combined music and ambient noise signals that are perceived by the wearer after noise reduction has taken place. There are two plots on this particular graph: one line represents the perceived noise level, to show the reduction of ambient noise when the music is playing (and the non-reduction when it is not), and the second shows the music level itself, to indicate track interval (Q-R) and music pause (S) events.

Initially, and up to point P, the music is switched off, and the music signal lies below the threshold level, causing the ambient noise reduction to be switched OFF. Consequently, the wearer hears the environmental ambient noise, at a level of about 75 dB. At point P, the wearer switches the music ON, which exceeds the threshold level, causing the noise reduction to be switched ON, thus reducing the perceived noise at the wearer's eardrum from 75 dB to 55 dB. At point Q the first music track stops and there is a short interval before the following track; the music signal falls below threshold, causing the noise reduction to switch OFF, and hence the wearer hears the ambient environment as normal, between tracks. At point R, the second music track starts, thus causing the ambient noise reduction to be switched ON again.

It will be understood that, without the noise reduction, the music and noise would have similar sound pressure levels at the eardrum of the wearer, making the music almost impossible to appreciate. At point S, the wearer wishes to leave the carriage and cross the platform to another train, and so the wearer pauses the music, causing the level to fall below threshold, thereby causing the DSP to switch off the noise reduction and allow the wearer to hear the ambient environment as normal, providing the safe default condition.

FIG. 8 shows a flow diagram indicative of a typical set of control functions that are employed in one embodiment of the Auto-Music Mode.

A further embodiment is depicted in FIG. 9, comprising an extension of the system of FIG. 4 by the addition of a third audio channel 35 with an electronically controllable gain stage 41, in addition to the ambient noise reduction channel and the music channel. The additional, third channel 35 represents a telecommunications channel, suitable for telephony, and is for relaying audio information to the listener's ears from a cellular phone or similar telephonic device, including internet-based telephony means. Such audio information includes both alerting means, such as ring-tones, and spoken word communications.

This arrangement permits implementation of a sophisticated audio management system on, for example, an ESD in the form of a wireless stereo earphone set networked to a cellular phone that is also equipped with a personal stereo (MP3) music player capability, as follows.
1. The wearer of the ESD is listening to music via the Bluetooth earphones, and with the ambient noise reduction switched ON. The various gain levels of stages 26, 28 and 41 are respectively set as:
Noise Reduction 100% ON; Music 100% ON; Telecomms 0% ON.
2. An incoming phone call is detected, which causes the following sequence of events to occur:
   (a) the music level is faded from 100% to 50% over a two second (say) period;
   (b) the noise reduction level is faded down from 100% to 50% over the same period;
   (c) the telecomms channel is faded up from 0% to 50% over a five second period.
This sequence gently reduces the music level and fades in a moderate amount of ambient noise to reach the wearer's ears, whilst at the same time gradually fading in the alerting ring-tone. This is less traumatic than a sudden, fully loud alert, and allows the wearer to become acclimatised to the immediate surroundings in order to assess the caller status and decide on whether to answer or refer the incoming call.
3. If the call is accepted, the following events occur.
   (a) the music level is faded from 50% to 0% over a two second (say) period;
   (b) the noise reduction level is faded back up again from 50% to 100% over the same period;
   (c) the telecomms channel is faded up to full almost immediately (0.2s).
This sequence reduces the music level to zero, invokes full ambient noise reduction and maximum telecom signal for optimum intelligibility during dialogue.
4. If the call is rejected, or at the end of the call, the initial listening conditions (1, above) are restored over a two second period.

This sequence of events allows smooth, automatic transitions between the multiple audio channels, and makes for a pleasant and comfortable user experience.

As regards all of the embodiments of the invention herein described, it will be appreciated that electronic components of the control system can be housed in the ESD, or in a separate housing or “pod” connected (directly or wirelessly) thereto, or may be distributed between the ESD and the pod, depending upon factors such as design choice and operational convenience.

Alternatively, the electronic processing, or one or more components associated therewith, can be integrated into a mobile electronic device such as a cellular phone handset or an MP3 personal music player.

Furthermore, any embodiment of the invention may be utilised in association with an audio system providing 3D-audio virtualisation.

Although the invention has been described with reference to certain specific embodiments, these embodiments have been provided, by way of example only, to illustrate the scope and advantages of the present invention, the scope of which is not intended to be restricted to the details of any such embodiment.

1. A noise reduction control system for an ear-worn speaker-carrying device (“ESD”) comprising means for sensing ambient noise on its way towards an ear of a wearer of the ESD, for developing electrical signals indicative of said noise and for utilising said signals to reduce the amount of said ambient noise audible to a wearer of the ESD, and control means for setting a plurality of predetermined and discrete levels for said reduction; said control means further comprising response means for automatically responding to at least one controlling event, outside the control of said wearer, to set the degree of said reduction to a preselected one of said discrete levels.

2. A system according to claim 1, wherein the system further comprises means for inverting and filtering said electrical signals and for feeding said inverted and filtered signals to a loudspeaker means in said ESD in time for the loudspeaker to generate sounds capable of interfering destructively with said sensed ambient noise when it arrives in the vicinity of said loudspeaker means.

3. A system according to claim 1, further comprising means for responding substantially instantaneously to said controlling event.

4. A system according to claim 1, further comprising means for responding to said controlling event in accordance with a predetermined time profile.

5. A system according to claim 4, wherein said predetermined time profile conforms to a ramp function.

6. A system according to claim 3, wherein said means for responding is adapted to change said degree of influence sequentially between a plurality of said discrete levels.

7. A system according to claim 2, comprising a source of further electrical signals relating to sounds intended for the wearer's attention, and means for merging the further electrical signals with the inverted and filtered signals to create a composite signal for application to said loudspeaker means.

8. A system according to claim 7, wherein the sounds intended for the wearer's attention comprise music.

9. A system according to claim 7, wherein the sounds intended for the wearer's attention comprise speech or other sounds received over a telecommunications link.

10. A system according to claim 7, wherein said control means is adapted to separately control the said inverted and filtered signals and the said further electrical signals relating to sounds intended for the wearer's attention.

11. A system according to claim 7, comprising plural channels for respective electrical signals relating to sounds intended for the wearer's attention, and wherein said control means is adapted to separately control the said signals in at least a first and a second of said channels.

12. A system according to claim 10, wherein said control means includes a digital signal processor.

13. A system according to claim 7, adapted to receive said signals for the attention of the wearer by way of direct electrical connections.

14. A system according to claim 7, adapted to receive said signals for the attention of the listener through wireless communication.

15. A system according to claim 14, wherein said wireless communication conforms to Bluetooth protocols.

16. A system according to claim 1, adapted to receive audio signals from an audio system providing 3D-audio virtualisation.

17. A system according to claim 1, in which the selected controlling event is a function of the sensed ambient noise level.

18. A system according to claim 7, in which the selected controlling event is a function of the sounds intended for the wearer's attention.

19. A system according to claim 1, in which the selected controlling event is a function of detected changes in physical motion of the ESD, representative of movement of the head of the wearer.

20. A personal music player incorporating one or more components of a system according to claim 1.

21. A cellular telephone incorporating one or more components of a system according to claim 1.

22. A noise reduction system comprising means for sensing ambient noise for developing electrical signals inclusive of said noise and for utilizing said signals to reduce the amount of said ambient noise audible to a wearer of the system, and control means for setting a plurality of predetermined and discrete levels for said reduction; said control means further comprising response means for automatically responding to at least one controlling event, outside the control of the wearer, to set the degree of said reduction to a preselected one of said discrete levels.
